(19) United States
(12) Patent Application Publication
(10) Pub. No.: US 2004/0140431 A1
(43) Pub. Date: Jul. 22, 2004

(54) Multi-application highly reflective grid array

(75) Inventors: Matthias J. Schmand, Lenoir City, TN (US); Niraj K. Doshi, Knoxville, TN (US); Lars A. Eriksson, Oak Ridge, TN (US)

Correspondence Address: PITTS AND BRITTIAN P C, P O BOX 51295, KNOXVILLE, TN, 37950-1295, US

(73) Assignee: CTI PET Systems, Inc., Knoxville, TN

(21) Appl. No.: 10/347,820

(22) Filed: Jan. 21, 2003

(51) Int. Cl. G01T 1/20

(52) U.S. Cl. 250/367

(57) ABSTRACT

A grid array adapted to receive a plurality of scintillators for use in association with an imaging device. The grid array is highly reflective such that location of the impingement of radiation upon an individual scintillator detector is accurately determinable. The grid array allows an air gap between each scintillator and the reflector material, as well as provides a highly reflective medium that produces sufficient light output while controlling cross-talk between the discrete scintillator elements. The grid array defines an M×N array of scintillator element cells. The grid array is manufactured using a conventional method such as injection molding. The grid array is fabricated from a highly reflective material. The scintillator elements are each cut to size and then inserted such that a uniform, flat surface to be achieved. In one embodiment, a bottom wall is be defined by each of the scintillator element cells. An opening is defined in the bottom wall for release of air within the cell as a scintillator element is being inserted therein. The opening may be further useful as a receptor for an optical fiber to be coupled to the scintillator element upon installation of the loaded grid array in an imaging device.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a detector and scintillator array for use in imaging applications such as X-ray imaging, fluoroscopy, positron emission tomography (PET), computed tomography (CT), gamma camera and digital mammography systems. More particularly, the present invention is a highly reflective scintillator detector grid array for a detector module which allows a quick and efficient method for creating a scintillator detector array from discrete detector elements.

2. Description of the Related Art

In the field of imaging, it is well known that imaging devices incorporate a plurality of scintillator arrays for detecting radioactivity from various sources. When constructing scintillator arrays composed of discrete scintillator elements, it is known that the scintillator elements must be packed together with a reflective medium interposed between the individual elements. The reflective medium serves to collimate the scintillation light to accurately assess the location at which the radiation impinges upon the detectors. The reflective medium further serves to increase the light collection efficiency from each scintillator element as well as to control the cross-talk, or light transfer, from one scintillator element to an adjacent element. Reflective mediums include reflective powders, reflective film, reflective paint, or a combination of materials.

Conventionally, scintillator arrays have been formed from polished crystals that are either hand-wrapped in reflective PTFE tape and bundled together, or alternatively, glued together using a white pigment such as BaSO₄ or TiO₂ mixed with an epoxy or RTV. The disadvantage of the former approach is that it is extremely labor intensive and difficult to control, the disadvantage of the latter approach is that by bonding the reflective material onto the surfaces of the crystal, light output is reduced substantially.

Another approach utilizes individual reflector pieces that are bonded to the sides of the scintillator element with the aid of a bonding agent. This process requires iterations of bonding and cutting until a desired array size is formed. This approach is also labor intensive and requires skilled workmanship. This approach creates a loss of an air gap between the reflector and the scintillator due to the bonding agent, thus resulting in a loss of light output.

Other devices have been produced to form an array of scintillator elements. Typical of the art are those devices disclosed in the following U.S. patents:

| U.S. Pat. No. | Inventor(s) | Issue Date |
|---|---|---|
| 3,936,645 | A. H. Iverson | Feb. 3, 1976 |
| 4,914,301 | Y. Akai | Apr. 3, 1990 |
| 4,982,096 | H. Fujii et al. | Jan. 1, 1991 |
| 5,059,800 | M. K. Cueman et al. | Oct. 22, 1991 |
| 6,292,529 | S. Marcovici et al. | Sept. 18, 2001 |

Of these patents, the '645 patent issued to Iverson discloses a radiation sensitive structure having an array of cells. The cells are formed by cutting narrow slots in a sheet of luminescent material. The slots are filled with a material opaque to either light or radiation or both. The '800 patent issued to Cueman et al., discloses a similar scintillator array wherein wider slots are formed on the bottom of the array.

### BRIEF SUMMARY OF THE INVENTION

The present invention is a grid array for use in imaging applications such as X-ray imaging, fluoroscopy, positron emission tomography (PET), computed tomography (CT), gamma camera and digital mammography systems. The grid array is adapted to receive a plurality of scintillators for use in association with an imaging device. The grid array is highly reflective such that location of the impingement of radiation upon an individual scintillator detector is accurately determinable. The grid array of the present invention allows the creation of a high light output, scintillator grid array in an efficient, consistent, accurate and cost-effective manner. The grid array allows an air gap between each scintillator and the reflector material, as well as provides a highly reflective medium that produces sufficient light output while controlling cross-talk between the discrete scintillator elements.

The grid array defines an M×N array of scintillator element cells. The grid array is manufactured using an injection molding process. Other methods of manufacture include using fused deposition modeling, SLA techniques, hand assembly, and other conventional manufacturing processes. In the injection molding process, the grid array is fabricated using a raw material in the form of pellets formed by blending a combination of polypropylene, titanium dioxide, barium sulfate, silicon dioxide, calcium carbonate, aluminum oxide, magnesium oxide, zinc oxide, zirconium oxide, talcum, alumina, Lumirror®, Teflon® (PTFE), calcium fluoride, silica gel, polyvinyl alcohol, ceramics, plastics, films and optical brightener. The materials of manufacture of the grid array are selected depending on the wavelength of light emitted by the scintillator in order to accomplish the highest degree of reflectance at the chosen wavelength.

The scintillator elements are each cut to size and then inserted by hand, or by any other means that allows a uniform, flat surface to be achieved. No bonding materials or agents are needed to hold the scintillator elements in place inside the grid. An air gap is defined between each scintillator and the side walls of the cell in which it is received as a result of there being no bonding of the scintillators to the grid array. The air gap maximizes light output as it minimizes loss of light into the reflector grid by providing a low index of refraction between the scintillator and the grid wall.

In one embodiment, a bottom wall is defined by each of the scintillator element cells. An opening is defined in the bottom wall for release of air within the cell as a scintillator element is being inserted therein. The opening in the bottom wall is further useful as a receptor for an optical fiber to be coupled to the scintillator element upon installation of the loaded grid array in an imaging device.

In an alternate embodiment, no bottom wall is provided, such that each end of the detector elements is exposed. In this embodiment, a fiber optic having a cross-section more closely approximating that of the detector elements may be coupled to each detector element.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective illustration of the grid array of the present invention;

FIG. 2 is a top plan view of the grid array of FIG. 1;

FIG. 3 is a bottom plan view of the grid array of FIG. 1;

FIG. 4 is a side elevation view of the grid array, in section, taken along lines 4-4 of FIG. 1;

FIG. 5 is a top plan view of an alternate embodiment of the grid array of the present invention;

FIG. 6 is a side elevation view of the grid array, in section, taken along lines 6-6 of FIG. 5;

FIG. 7 is an energy resolution map acquired from a radioactive event using a block detector of the prior art wherein silicon dioxide is packed between individual crystals;

FIG. 8 is a graphical illustration of the energy peaks relative to each crystal in a single row of crystals of the block detector used to acquire the energy resolution map of FIG. 7;

FIG. 9 is an energy resolution map acquired from flood irradiating the block detector of the present invention; and

FIG. 10 is a graphical illustration of the energy peaks relative to each crystal in a single row of crystals of the block detector used to acquire the energy resolution map of FIG. 9.

### DETAILED DESCRIPTION OF THE INVENTION

A grid array for use in imaging applications such as X-ray imaging, fluoroscopy, positron emission tomography (PET), computed tomography (CT), gamma camera and digital mammography systems is provided. The grid array is illustrated at 10 in the figures. The grid array 10 is adapted to receive a plurality of scintillators 12 for use in association with an imaging device (not illustrated). The grid array 10 is highly reflective such that location of the impingement of radiation upon an individual scintillator detector 12 is accurately determinable. The present invention provides for the creation of a high light output, scintillator grid array 10 in an efficient, consistent, accurate and cost-effective manner. An air gap 14 is formed between each scintillator 12 and the reflector material, as well as provides a highly reflective medium that produces sufficient light output while controlling cross-talk between the discrete scintillator elements 12.

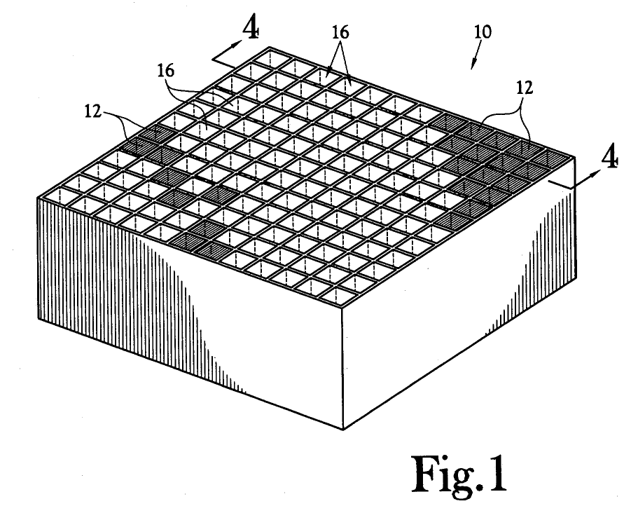

As best illustrated in FIG. 1, the grid array 10 defines an M×N array of scintillator element cells 16. In the illustrated embodiment, the grid array 10 defines a 12×12 matrix of scintillator element cells 16. However, it will be understood that “M” and “N” are independently selectable, with “M” being less than, equal to, or greater than “N”. It will be understood that, while the grid array 10 is illustrated as defining square scintillator element cells 16 of similar size, it will be understood that the scintillator element cells 16 of the present invention are not limited to this configuration. The scintillator element cells 16 define a cross-section of one or a combination of more than one geometric configuration such as circular, triangular, rectangular, hexagonal, and octagonal.

The grid array 10 is manufactured using an injection molding process. The grid array 10 is fabricated from pellets formed by blending a combination of polypropylene, titanium dioxide, Teflon® and an optical brightener. While the dimensions are variable depending upon the particular use, in the illustrated embodiment, each scintillator element cell 16 defines a cross-sectional dimension of 4×4 mm and a depth of 20 mm. In this embodiment, the grid wall 18 thickness is 0.3 mm. In one embodiment, the grid wall 18 defines a draft or taper of approximately 0.1 degree. The tapering in the thickness of the grid wall 18 assists the scintillator to be held in place without any bonding agents. The exterior dimensions of the grid 10 in this embodiment, therefore, are approximately 52×52×20 mm. The scintillator elements 12 are each cut to size and then inserted by hand, or by any other means that allows a uniform, flat surface to be achieved. No bonding materials or agents are needed to hold the scintillator elements 12 in place inside the grid array 10. Although not clearly visible in the illustrations, an air gap 14 is defined between each scintillator element 12 and the side walls 18 of the cell 16 in which it is received. The air gap 14 is a result of there being no bonding of the scintillator elements 12 to the grid array 10. This air gap 14 maximizes light output as it minimizes loss of light into the reflector material of the grid array 10.

The grid array 10 is manufactured using one or more of a variety of materials including reflective powders, plastics, paints, ceramics, or other highly reflective components. Similarly, the grid array 10 is manufactured using one of a variety of processes including, but not limited to, injection molding, fused deposition modeling, SLA techniques, or hand assembly using reflective materials. The grid array 10 is dimensioned at various lengths and wall 18 thicknesses to accommodate various sized scintillator elements 12. The grid array 10 is constructed to have parallel scintillator element cells 18 or, alternatively, to define scintillator element cells forming an arch (not illustrated).

In one embodiment of the present invention, pellets used in the injection molding process are created using a blend of 20% titanium dioxide (TiO2), 2% Teflon®, 0.2% optical brightener, and polypropylene. The grid array 10 is formed by injecting the pellets using a high pressure injection molding machine and customized dies and tooling to form the grid array 10. The materials of manufacture of the grid array 10 are selected depending on the wavelength of light emitted by the scintillator element 12 in order to achieve the highest degree of reflectance at the chosen wavelength. Materials that have been used singly or in combination include, but are not limited to Titanium dioxide, Barium sulfate, Silicon dioxide, Calcium carbonate, Aluminum oxide, Magnesium oxide, Zinc oxide, Zirconium oxide, Talcum, Alumina, Lumirror®, Teflon® (PTFE), Calcium fluoride, Silica gel, Polyvinyl alcohol, Ceramics, Plastics, and films.

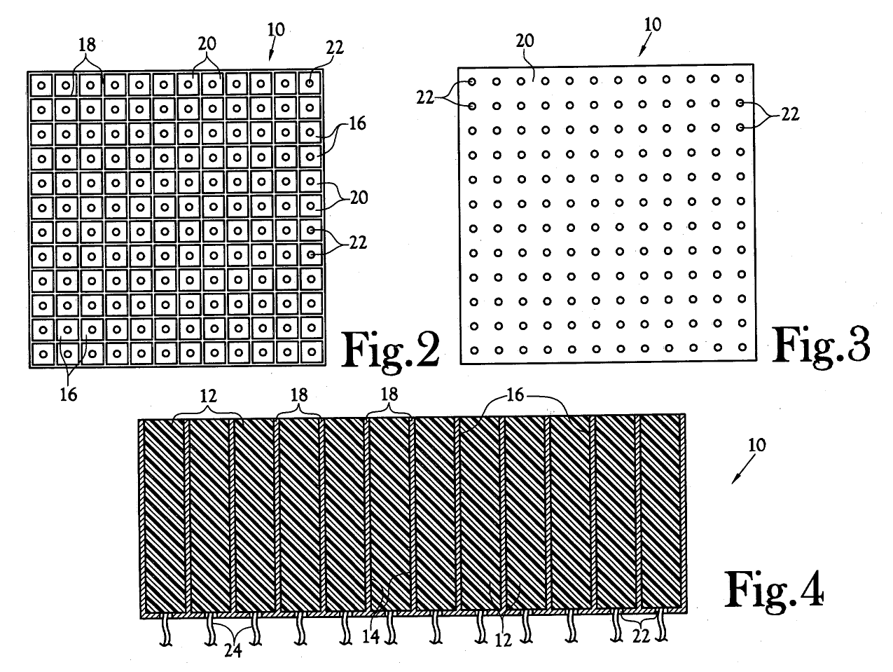

In the embodiment illustrated in FIG. 2, each of the scintillator element cells 16 defines a bottom wall 20. An opening 22 is defined in the bottom wall 20 for release of air within the cell 16 as a scintillator element 12 is being inserted therein. Although not illustrated, the opening 22 is also useful as a receptor for an optical fiber (not shown) to be coupled to the scintillator element 12 upon installation of the loaded grid array 10 in an imaging device. It will be understood that optical fibers may or may not be used depending on the application and design of the imaging device.

FIG. 3 illustrates the bottom wall 20 of the grid array 10, more clearly illustrating the opening 22 in each of the scintillator element cells 16.

Finally, FIG. 4 illustrates a cross-sectional view of the grid array 10 loaded with scintillator elements 12. The array of scintillator detectors 12 is coupled to at least one photodetector including, but not limited to, a photomultiplier tube, an avalanche photodiode, a pin diode, a CCD, or another solid state detector. In this arrangement, the scintillators 12 disposed within the grid array 10 serve to detect an incident photon and thereafter produce a light signal corresponding to the amount of energy deposited from the initial interaction between the photon and the scintillator element 12. The grid array 10 serves to reflect and channel the light down the scintillator element 12 to the coupled photodetector. The signal generated by the photodetector is then post-processed and utilized in accordance with the purpose of the imaging device.

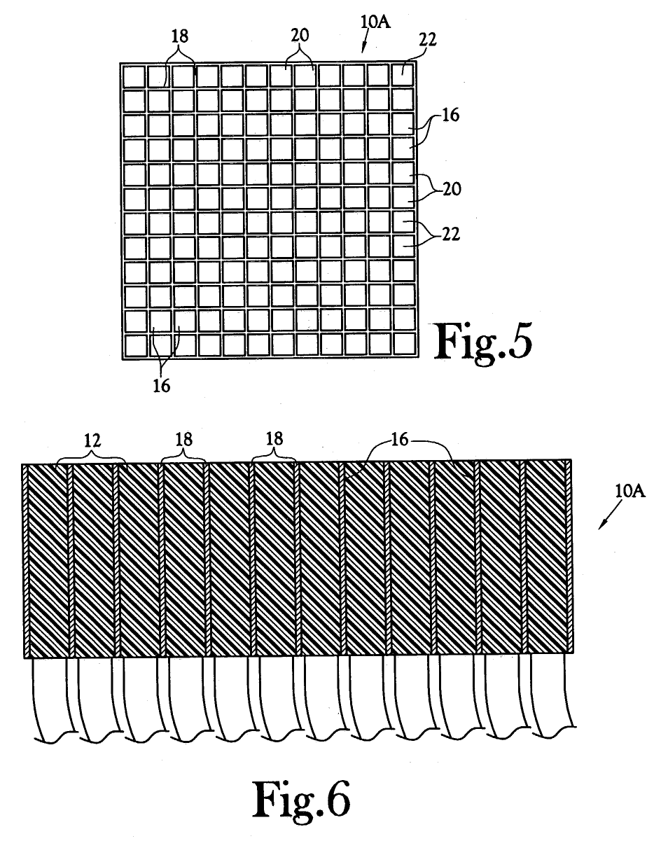

FIGS. 5 and 6 illustrate an alternate embodiment of the grid array 10A of the present invention. The configuration of the grid array 10A is similar to that of the grid array 10 with the exception that the bottom wall 20 of the grid array 10 is not present. To this extent, the bottom wall 20 is either removed from the grid array 10 to fabricate the grid array 10A, or the grid array 10A is fabricated without a bottom wall 20. Because the entire surface of each end of the scintillator elements 12 are exposed, it will be seen that optical fibers having a cross-section more closely approximating that of the scintillator elements 12 are coupled to the scintillator elements 12 in order to achieve more accurate detection of scintillation events within each scintillator element 12. Further, with respect to the grid array 10A, the reflective grid along with the scintillator elements 12 are directly attachable to the signal receiver such as a PMT, photodiode, an avalanche photodiode, and the like.

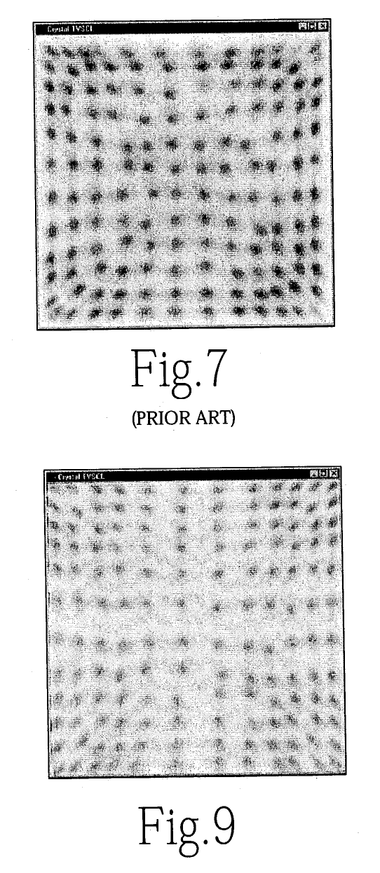

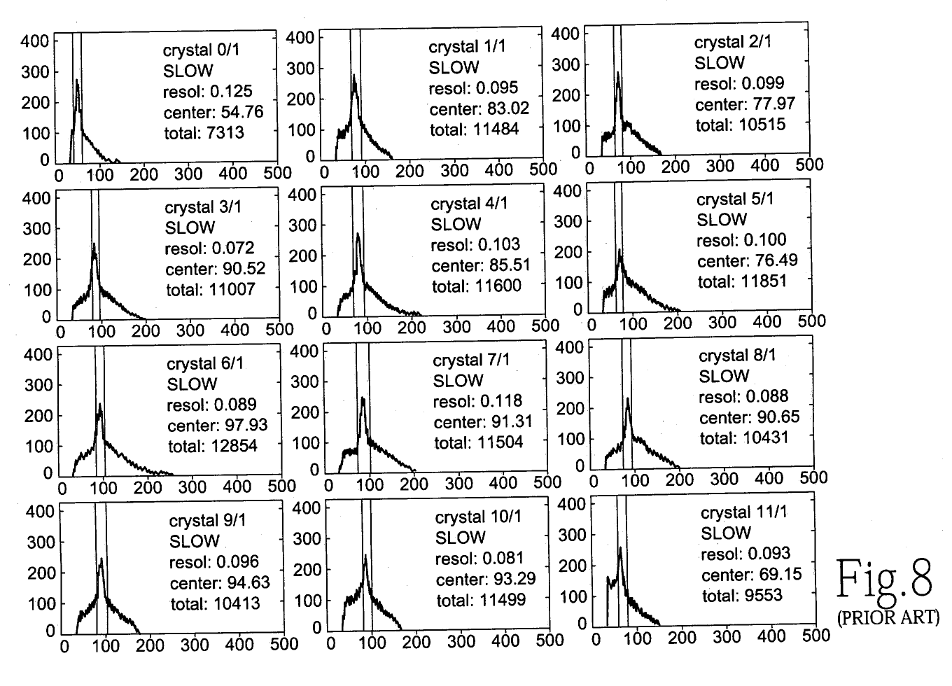

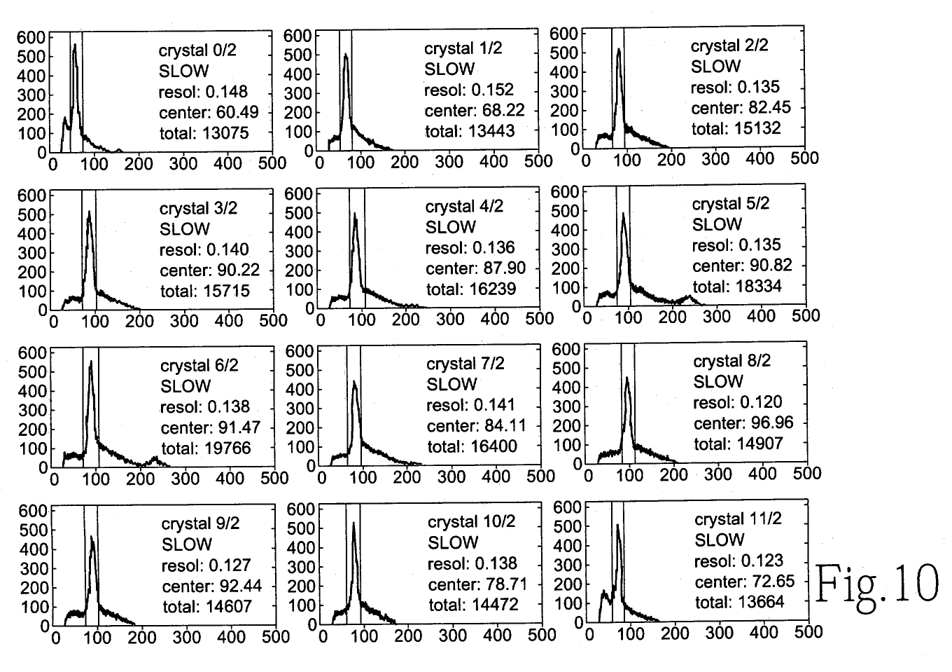

FIGS. 7-10 illustrate a comparison of energy resolutions using a block detector of the prior art and a block detector of the present invention. Specifically, FIG. 7 illustrates an energy resolution map acquired from flood irradiating a block detector of the prior art wherein silicon dioxide is packed between individual crystals, and FIG. 9 illustrates an energy resolution map acquired from flood irradiating a block detector of the present invention. FIG. 8 illustrates the energy peaks relative to each crystal in a single row of crystals of the prior art block detector used to acquire the energy resolution map of FIG. 7. FIG. 10 illustrates the energy peaks relative to each crystal in a single row of crystals of the block detector used to acquire the energy resolution map of FIG. 9. In this example, it will be noted that the efficiency of each scintillator element 12 in the block detector of the present invention is higher than that from the prior art, comparing FIGS. 8 and 10. Using the present invention, the energy peaks are generally higher and the background noise is relatively lower. While there are intrinsic differences in the energy resolutions that are independent of the type of reflector used, the grid array 10 of the present invention provides results at least equal to and typically better than the current state of the art.

From the above description, it will be recognized by those skilled in the art, that a grid array having high reflectivity has been disclosed. The grid array is manufactured using a consistent, cost-effective method. Further, the grid array of the present invention eliminates the need to hand-wrap, or paint individual scintillator elements. The grid array is adapted to receive a plurality of scintillators for use in imaging applications such as X-ray imaging, fluoroscopy, positron emission tomography (PET), computed tomography (CT), gamma camera and digital mammography systems. The grid array allows an air gap between each scintillator and the reflector material, as well as provides a highly reflective medium that produces sufficient light output while controlling cross-talk between the discrete scintillator elements.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparati and methods, and illustrative examples shown and described. Accordingly, departures may be made from such details without departing from the spirit or scope of the general inventive concept.

Having thus described the aforementioned invention, we claim:

1. A grid array adapted to receive a plurality of scintillators for use in association with an imaging device, said grid array comprising:
an M×N array of scintillator element cells where “M” and “N” are independently selectable, each of said scintillator element cells being defined by a side wall adapted to closely receive a scintillator element of a selected cross sectional configuration, said grid array being fabricated from a material selected to maximize light reflection at a wavelength particular to the scintillator elements.

2. The grid array of claim 1 wherein each of said array of scintillator element cells further defines a bottom wall, said bottom wall defining an opening.

3. The grid array of claim 2 wherein said opening in said bottom wall of each of said array of scintillator element cells is provided for receiving an optic fiber to be coupled to the scintillator element.

4. The grid array of claim 1 wherein the scintillator elements are received within each of said scintillator element cells without a binding agent, an air gap being defined between each scintillator element and said side wall of said scintillator element cell, said air gap maximizing light output by minimizing loss of light into said side wall of each of said scintillator element cells.

5. The grid array of claim 1, said grid array being fabricated from at least one component selected from the group consisting of at least: reflective powders, plastics, paints, ceramics, titanium dioxide, barium sulfate, silicon dioxide, calcium carbonate, aluminum oxide, magnesium oxide, zinc oxide, zirconium oxide, talcum, alumina, Lumirror®, Teflon®, calcium fluoride, silica gel, polyvinyl alcohol, and films.

6. The grid array of claim 5 wherein said grid array is fabricated from a composition including 20% titanium dioxide (TiO₂), 2% Teflon®, 0.2% optical brightener, and polypropylene.

7. The grid array of claim 1, said grid array being manufactured using an injection molding process.

8. The grid array of claim 1 wherein said grid array is manufactured using fused deposition modeling.

9. The grid array of claim 1 wherein said grid array is manufactured using SLA techniques.

10. The grid array of claim 1 wherein said grid array is manufactured using hand assembly.
